(19) United States
(12) Patent Application Publication
(10) Pub. No.: US 2009/0101083 A1
(43) Pub. Date: Apr. 23, 2009

(54) APPARATUS FOR TRAINING OR EXERCISING ONE OR MORE DOGS

(76) Inventor: REBECCA E. COLLA, ALBUQUERQUE, NM (US)

Correspondence Address: KENNEDY, LTD., 3916 JUAN TABO NE, SUITE 14, ALBUQUERQUE, NM, 87110, US

(21) Appl. No.: 12/255,856

(22) Filed: Oct. 22, 2008

Related U.S. Application Data
(60) Provisional application No. 60/981,607, filed on Oct. 22, 2007.

(51) Int. Cl. A01K 27/00

(52) U.S. Cl. 119/770

(57) ABSTRACT

The present invention includes an apparatus for exercising one or more dogs including an adjustable belt portion having a variable length of 2L and a second belt portion independently connected to the adjustable belt portion. The apparatus can also include at least two connectors adapted to connect to one or more leads. The at least two connectors can be attached to the adjustable belt portion such that they define a distance L there between in response to any adjustment of the belt portion to any length 2L. The placement of the at least two connectors encourages maximizing the distance between any two dogs that a user may be exercising at one time.

### CLAIM OF PRIORITY UNDER 35 U.S.C. §119

The present Application for Patent claims priority to Provisional Application No. 60/981,607 entitled “Apparatus for Training or Exercising One or More Dogs,” filed Oct. 22, 2007, and assigned to the assignee hereof and hereby expressly incorporated by reference herein.

### TECHNICAL FIELD

The present invention relates generally to the field of pet goods, and more specifically to the field of apparatuses for training and/or exercising one or more dogs.

### BACKGROUND

In the United States and other countries, many people have pets such as dogs for companionship and entertainment. For dog owners in particular, it is not uncommon for owners to have more than one dog in their family, either of the same or different breed, age or gender. One important aspect of owning any dog is that the owner must take responsibility for both the training and exercising of the dog, which more often than not, takes place on the end of a leash or lead. Many dog owners use the daily walk as an opportunity to both exercise the dog and to teach it basic commands such as sit, stay and down. More advanced dog owners or competitors also teach their dogs how to heel or trot alongside the owner without passing in front of the owner.

It is a fairly well accepted principle that even domesticated dogs maintain a pack instinct, and are thus always in search of a pack leader. Any given dog can attempt to establish its dominance over its owner on a walk by leading the walk, such that it is the dog that is walking its owner and not the other way around. Owners oftentimes overlook this type of behavior, but it can lead to a number of problems in other areas ranging from restlessness and anxiety to dominance in aggression. For owners with multiple dogs, any type of training on a lead can be complicated due to the fact that the dogs might try to compete with each other, as well as the owner, to establish a dominant position in the social structure. This competition often involves a dog trying to lead its pack on the walk, which when combined with another dog trying to do the same, can be instantly overwhelming for the owner holding the other end of the leads.

Numerous hands-free devices have been developed for dog walking or training. Usually, these devices employ some type of belt-apparatus that the user/owner attached around his or her waist, thereby freeing his or her hands for other activities. While these devices provide a number of benefits, especially for the elderly or infirm, they do nothing to prohibit competitive behavior on behalf of the dog(s) that are being walked. Accordingly, there is a need in the art for a new device or apparatus that allows for the hands-free training and/or exercising of one or more dogs that also encourages good behavior on the part of the animal.

### SUMMARY OF THE PRESENT INVENTION

As described below in greater detail with reference to its preferred embodiments, the present invention includes an apparatus for exercising one or more dogs including an adjustable belt portion having a variable length of 2L and a second belt portion independently connected to the adjustable belt portion. The apparatus can also include at least two connectors adapted to connect to one or more leads. The at least two connectors can be attached to the adjustable belt portion such that they define a distance L there between in response to any adjustment of the belt portion to any length 2L. As noted below, the placement of the at least two connectors encourages maximizing the distance between any two dogs that a user may be exercising at one time. Additionally the apparatus can include a lead having a first lead connector adapted for connecting to one of the at least two connectors and a second lead connector adapted for connecting to a collar. The lead can further include at least one intermediate connector adapted to receive one of the first lead connector or the second lead connector for adjusting the length and/or function of the lead.

### BRIEF DESCRIPTION OF THE FIGURES

FIG. 1 is a frontal view of an apparatus for training and/or exercising dogs in accordance with a preferred embodiment of the present invention.

FIG. 2 is a plan view of the apparatus shown in FIG. 1.

FIG. 3 is a frontal view of a lead portion of the apparatus shown in FIGS. 1 and 2.

### DESCRIPTION OF THE PREFERRED EMBODIMENTS

The following description of the preferred embodiment of the invention is not intended to limit the invention to this preferred embodiment, but rather to enable any person skilled in the art of pet equipment to make and use this invention.

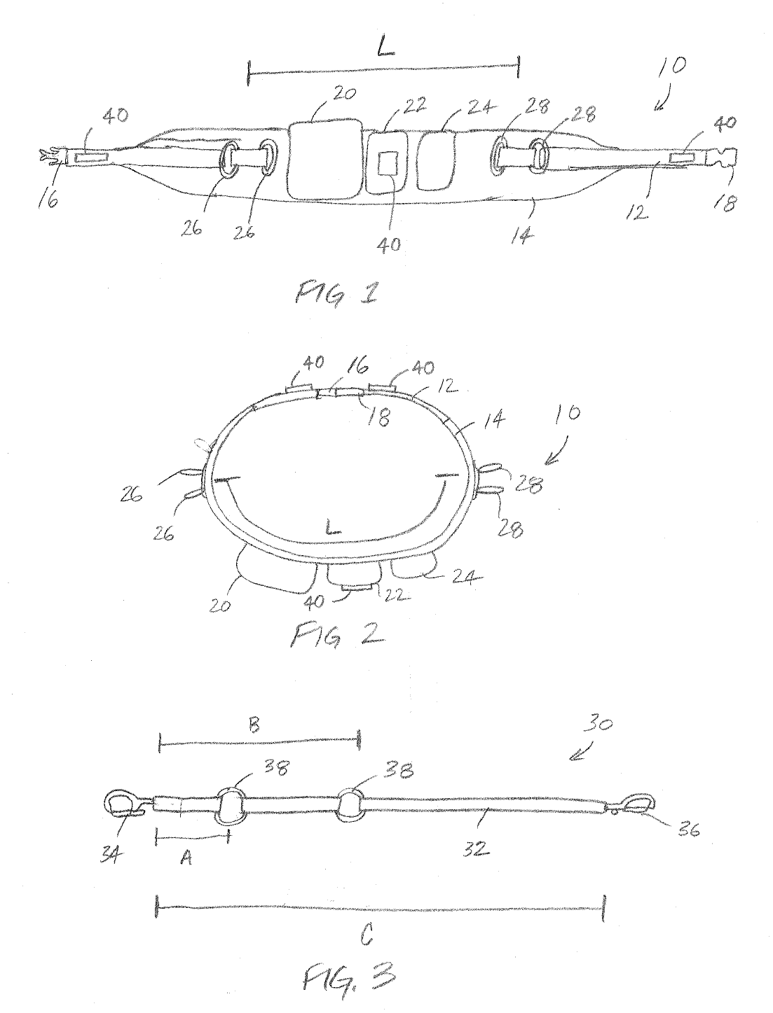

As shown in FIGS. 1 and 2, an apparatus 10 in accordance with the preferred embodiment is generally defined by an adjustable belt portion 12 and a second belt portion 14. The adjustable belt portion 12 can be connected to itself via connectors 16, 18, thereby allowing a user to fasten the apparatus 10 around his or her waist or hips for hands-free use. The adjustable belt portion 12 can be adjusted to accommodate different waist circumferences. The second belt portion 14 can be substantially wider than the adjustable belt portion 12, and can include a padded, cushioned or other comforting structure and/or fabric. In one variation of the apparatus 10 of the preferred embodiment, the second belt portion 14 can be configured discretely or integrally with the adjustable belt portion 12, such that adjustments to the adjustable belt portion 14 can occur independently of the second belt portion 14, i.e. the adjustable belt portion 12 can be adjusted without affecting the overall length of the second belt portion 14 such that the length of the adjustable belt portion 12 is variable while the length of the second belt portion 14 is fixed. The adjustable belt portion 12 can include an adjustment mechanism, such as hook-and-loop closures, cams, buckles, buttons, latches and the like for adjusting the length 2L such that it fits snugly and securely about a user's waistline.

The apparatus 10 can further include one or more containers 20, 22, 24 attached to one of the adjustable belt portion 12 or the second belt portion 14. The containers 20, 22, 24 can be used by the owner for carrying various articles, such as treats, plastic bags, mobile phones, portable music players, and/or training or exercising accessories. The containers 20, 22, 24 can also feature various closure means or mechanisms, such as zippers, buttons, latches and the like.

The apparatus 10 can further include one or more lights 40 disposed at one or more locations along the apparatus 10. As shown for example in FIGS. 1 and 2, a plurality of lights 40 are disposed on opposing sides of the apparatus 10 such that a user can both see and be seen when walking one or more dogs at night. Alternatively, the apparatus 10 can include a reflective surface (not shown) disposed in predetermined locations for safety measures, as well as one or more lights 40 for allowing the user to see his or her pathway. The reflective surface can include for example reflective tape, fabric, gel, and the like for ensuring the safety of the user and his or her dog(s).

The apparatus 10 can further include one or more connectors 26 disposed on a first side of the second belt portion 14 and one or more connectors 28 disposed on a second side of the second belt portion 14. In one example embodiment, the connectors 26, 28 are disposed on the second belt portion 14 at a predetermined distance L from each other, wherein the predetermined distance is calculated to dispose the connectors 26, 28 on opposing side of the user's hips during use. The predetermined distance L can be configured to fluctuate according to the adjustments of the adjustable belt portion 12, such that the connectors 26, 28 are always ideally placed irrespective of the overall length of the apparatus 10. That is, the predetermined distance L can be defined as approximately one half of the circumference of the apparatus 10, independent of the overall circumference as determined by the user. As noted above, the adjustable belt portion 12 and the second belt portion 14 can be arranged such that the overall length (2L) of the adjustable belt portion 12 can be adjusted independently from the second belt portion 14. Thus, as the distance L is increased or decreased through adjustment, the relative position of the connectors 26, 28 and the second belt portion 14 will remain unchanged such that when in use, the connectors 26, 28 are disposed on substantially opposing sides of the apparatus 10 and in substantial alignment with a user's respective flanks.

By placing the connectors 26, 28 on opposing sides of a user's hips when in use, the apparatus 10 of the preferred embodiment ensures the correct positioning of one or more dogs relative to the user's body, i.e. adjacent to or behind the user. Moreover, by separating the connectors 26, 28, the apparatus 10 of the preferred embodiment further eliminates any competitive pressures that might arise when walking two dogs simultaneously. By separating the dogs on either side of the user, the apparatus 10 of the preferred embodiment minimizes the visual contact between the dogs, which in turn can lessen any competitive pressures that typically arise during exercise or training.

The apparatus 10 of the preferred embodiment can be used with one or more leads, such as an example lead 30 shown in FIG. 3. The lead 30 generally defines an lead portion 32 that can be composed of a synthetic material such as nylon or a natural material such as leather. The lead 30 can include first and second lead connectors 34 and 36, both of which can be connected to either an apparatus 10 of the type described herein and a collar or other restraining device for a dog. The lead 30 can also include one or more intermediate connectors 38, to which one or both of the first and second lead connectors 34, 36 can be connected.

In use, for example, a user can connect the lead 30 to the apparatus 10 by fastening first lead connector 34 to one of connectors 26, 28, while second lead connector 36 can be connected to the collar of the dog. Alternatively, a user can connect the lead 30 to itself, thereby making a loop or handle in the lead 30 by connecting first lead connector 34 to intermediate connector 38. This would allow a user to use the lead 30 independently of the apparatus 10. In another alternative, the user could loop the lead 30 through one of connectors 26, 28 and then connect first lead connector 34 to intermediate connector 38. In this manner, the user can effectively shorten the overall length C of the lead 30 by a length of one half of length A or B. Accordingly, the user can implement the various features of the lead 30 to vary the lead function and the lead length, which allows the user to have greater control over his or her dog(s).

As a person skilled in the art of pet equipment will recognize from the previous detailed description and from the figures and claim, modifications and changes can be made to the preferred embodiment of the invention without departing from the scope of this invention defined in the following claims.

I claim:

1. An apparatus for exercising one or more dogs comprising:
an adjustable belt portion having a variable length of 2L;
a second belt portion connected to the adjustable belt portion; and
at least two connectors adapted to connect to one or more leads, the at least two connectors attached to the adjustable belt portion and defining a distance L there between in response to any adjustment of the adjustable belt portion to any length 2L.

2. The apparatus of claim 1, further comprising a lead comprising a first lead connector adapted for connecting to one of the at least two connectors, a second lead connector adapted for connecting to a collar, and at least one intermediate connector adapted to receive one of the first lead connector or the second lead connector for adjusting the length of the lead.

3. The apparatus of claim 1, wherein the second belt portion further comprises one or more containers.

4. The apparatus of claim 1, further comprising one or more lights disposed on one of the adjustable belt portion or the second belt portion.

5. The apparatus of claim 1, wherein the adjustable belt portion is adjustable such that the length 2L is substantially a circumference of a user.

6. The apparatus of claim 1, further comprising a reflective surface disposed on one of the adjustable belt portion or the second belt portion.

7. The apparatus of claim 1, wherein the adjustable belt portion and the second belt portion comprise an integrated unit.
